(19) United States
(12) Patent Application Publication
(10) Pub. No.: US 2019/0116718 A1
(43) Pub. Date: Apr. 25, 2019

(54) WORKING MACHINE LIFTING CONTROL DEVICE

(71) Applicant: KYB Corporation, Tokyo (JP)

(72) Inventors: Tatsuo ITO, Kanagawa (JP); Tooru MATSUURA, Kanagawa (JP)

(73) Assignee: KYB Corporation, Tokyo (JP)

(21) Appl. No.: 16/092,473

(22) PCT Filed: Jan. 27, 2017
(86) PCT No.: PCT/JP2017/002957

§ 371 Date: Oct. 10, 2018

(30) Foreign Application Priority Data
Apr. 28, 2016 (JP) 2016-091545

(51) Int. Cl. A01B 63/10; B66B 1/34; B66B 1/40; F15B 13/02; F15B 21/08

(52) U.S. Cl. CPC A01B 63/10; B66B 1/3407; F15B 21/087; F15B 13/02; B66B 1/405

(57) ABSTRACT

A lifting control device includes: a position acquisition portion configured to acquire an extended or contracted position of the hydraulic cylinder; a target setting portion configured to set a target position of the hydraulic cylinder; a control portion configured to control an energized amount of the solenoid valve; and an input judging portion configured to judge whether the operational input is an opening command to perform an opening control in which the solenoid valve is made to be fully open or is a positional control command to perform a positional control in which the solenoid valve is actuated according to an operation input amount to control the extended or contracted position of the hydraulic cylinder, wherein when the operational input is judged as the opening command by the input judging portion, the opening control is performed due to the non-integral type control by the control portion.

### TECHNICAL FIELD

The present invention relates to a lifting control device of a working machine.

### BACKGROUND ART

JP2002-223605A discloses a control device that controls working current values of an electromagnetic proportional control valve for adjusting a supplied amount of working oil to a hydraulic actuator that drives a working device. This control device receives a setting signal from a setting station that sets a target working amount with respect to the hydraulic actuator and a detection signal from a working position detecting sensor that detects a working position of the hydraulic actuator, sets an amount of working oil on the basis of the target working amount from the setting station, and calculates a working current value of the electromagnetic proportional control valve on the basis of oil amount−current property from the working oil amount.

### SUMMARY OF INVENTION

As a lifting control device of a working machine, there is one in which a solenoid valve energized amount is controlled by a positional feedback control on the basis of a position deviation between a target position and an actual position of a fluid pressure actuator that lifts and lowers the working machine, to control an extended or contracted position of the fluid pressure actuator.

More specifically, the lifting control device performs a positional control for controlling the solenoid valve energized amount to have the target position according to an operational input amount by the worker agree with the actual position of the fluid pressure actuator, or an opening control to have an opening degree of the solenoid valve be of a predetermined set opening degree to cause the fluid pressure actuator to contract by self-weight of the working machine according to the operational input by the worker. In the positional control, the opening degree of the solenoid valve is controlled within a range of not more than the set opening degree. In the opening control, the target position is set as a position in a contracting direction than the most contracted position of the fluid pressure actuator, to ensure that the position deviation is of a negative value and the solenoid valve is in the set opening degree, regardless of where the actual position of the fluid pressure actuator is. This allows for energizing the solenoid valve with a current value that makes the solenoid valve be in a set opening degree, to contract the fluid pressure actuator by the self-weight of the working machine. Such a positional feedback control is performed by a proportional integral control (PI control), to reduce a steady-state deviation and improve control accuracy.

However, with a work vehicle in which a working machine is installed, work may be performed while running and keeping a state in which the fluid pressure actuator is moved to a stroke end due to self-weight, due to the opening control. When the state in which the extended or contracted position of the fluid pressure actuator is kept at the stroke end due to the opening control, a negative position deviation is continuously applied to the lifting control device. Thus, a negative integral value is accumulated due to the proportional integral control in the positional feedback control.

Therefore, even if the state in which the opening control is continued is switched to the positional control and a target position according to the operational input by the worker is provided, the solenoid valve will not be energized and the fluid pressure actuator will not extend until a positive integral value is accumulated that would eliminate the accumulated negative integral values.

An object of the present invention is to improve responsiveness during a lifting operation, in a lifting control device of a working machine.

According to one aspect of the present invention, a lifting control device of a working machine, which is configured to control movements of a lifting device, the lifting device including a fluid pressure actuator configured to lift and lower a working machine installed on a work vehicle, and a solenoid valve configured to control a flow of working fluid supplied to and discharged from the fluid pressure actuator, includes: a position acquisition portion configured to acquire an extended and contracted position of the fluid pressure actuator; a target setting portion configured to set a target position of the fluid pressure actuator according to an operational input by a worker; a control portion configured to control an energized amount of the solenoid valve; and an input judging portion configured to judge whether the operational input is an opening command to perform an opening control in which an opening degree of the solenoid valve is made to be a predetermined set opening degree regardless of an extended or contracted position of the fluid pressure actuator or is a positional control command to perform a positional control in which the opening degree of the solenoid valve is made to be a smaller opening degree than the set opening degree according to an operational input amount, to control the extended or contracted position of the fluid pressure actuator. The control portion is configured to perform a proportional integral control on the basis of a position deviation between the target position set by the target setting portion and an actual position acquired by the position acquisition portion, and a non-integral type control performing no integration of the position deviation. When the operational input is judged as the positional control command by the input judging portion, a position within a stroke region between a most extended position and a most contracted position is set as the target position according to the operation input amount by the target setting portion, and the positional control is performed due to the proportional integral control by the control portion. When the operational input is judged as the opening command by the input judging portion, a position exceeding the most contracted position from the stroke region is set as the target position by the target setting portion, and the opening control is performed due to the non-integral type control by the control portion.

### BRIEF DESCRIPTION OF DRAWINGS

FIG. 1 is a schematic view showing a configuration of a lifting device including a lifting control device of a working machine according to an embodiment of the present invention.

FIG. 2 is a schematic view showing a main volume installed in the work vehicle including the lifting control device of a working machine according to an embodiment of the present invention.

FIG. 3 is a block diagram showing a configuration of the lifting control device of a working machine according to an embodiment of the present invention.

FIG. 4 is a block diagram showing a configuration of a control portion in the lifting control device of a working machine according to an embodiment of the present invention.

FIG. 5 is a graph showing a relationship between operational inputs and target positions in the lifting control device of a working machine according to an embodiment of the present invention.

### DESCRIPTION OF EMBODIMENTS

Described below with reference to the drawings is a lifting control device 100 for a working machine according to an embodiment of the present invention.

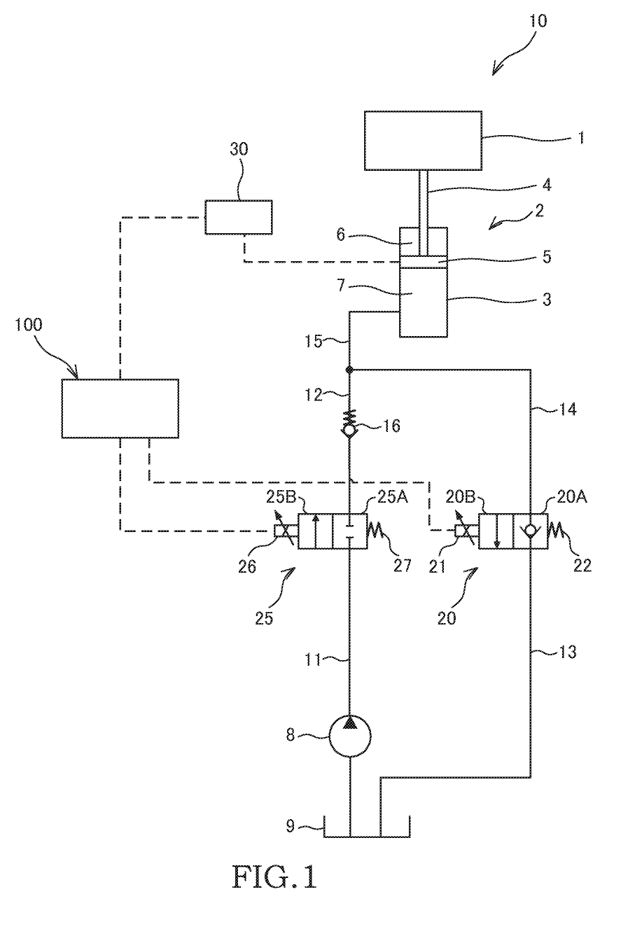

First described with reference to FIG. 1 is an overall configuration of the lifting control device 100 for a working machine (hereinafter, simply referred to as “control device 100”) and a lifting device 10 of the working machine including the control device 100.

The lifting device 10 is, for example, installed in a tractor that serves as a work vehicle, and lifts and lowers a working machine provided on a rear portion of the tractor. The working machine is, for example, a tillage device (not shown) for preparing agricultural land, which is mounted in a detachable manner to a link mechanism via a hitch device (not shown).

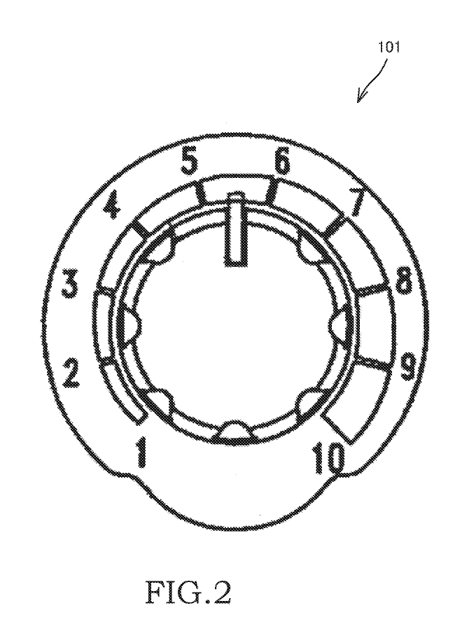

The work vehicle is provided with a main volume 101 (see FIG. 2) that allows for switching between a positional control and an opening control later described. The main volume 101 has an operational scale of “1” to “10”, and operational inputs are inputted into the control device 100 according to its operated position.

The lifting device 10 includes a hydraulic cylinder 2 serving as a fluid pressure actuator, which extends and contracts by supplying and discharging working oil that serves as working fluid, to drive a link mechanism (load 1) of the working machine in a vertical up-down direction, a pump 8 for supplying the working oil to the hydraulic cylinder 2, a tank 9 to which the working oil discharged from the hydraulic cylinder 2 is guided, a first valve 20 and a second valve 25 that serve as solenoid valves, for controlling flows of working oil supplied from and discharged to the hydraulic cylinder 2, a stroke sensor 30 serving as a detecting portion for detecting an extended or contracted position of the hydraulic cylinder 2, and the control device 100 that controls the extending and contracting operation of the hydraulic cylinder 2 by controlling energized amounts of the first valve 20 and the second valve 25.

The hydraulic cylinder 2 has a cylinder-shaped cylinder tube 3, a piston rod 4 to be inserted inside the cylinder tube 3, and a piston 5 provided on an end of the piston rod 4 and which slidably moves along an inner surface of the cylinder tube 3.

The inside of the cylinder tube 3 is partitioned by the piston 5 into a rod side chamber 6 and a bottom side chamber 7. The hydraulic cylinder 2 is a single-acting hydraulic cylinder whose rod side chamber 6 is open to the air and whose bottom side chamber 7 is filled with working oil. The hydraulic cylinder 2 extends caused by pressure of the working oil supplied to the bottom side chamber 7. When a working oil pressure of the bottom side chamber 7 decreases, the piston rod 4 and the piston 5 move downwards due to the self-weight of the working machine, and the hydraulic cylinder 2 contracts.

The hydraulic cylinder 2 is not limited to the single-acting type in which working oil is filled into the bottom side chamber 7, and other forms may be employed. For example, the hydraulic cylinder 2 may be a double-acting type in which working oil is supplied to and discharged from both of the rod side chamber 6 and the bottom side chamber 7. Moreover, the hydraulic cylinder 2 may be a single-acting type in which working oil is supplied to and discharged from the rod side chamber 6 and the bottom side chamber 7 is open to the air. Moreover, the hydraulic cylinder 2 may be a ram type in which no piston 5 is provided.

The first valve 20 and the second valve 25 are proportional solenoid valves in which a spool (not shown) moves to a position where respective electromagnetic force generated by energizing the solenoids 21 and 26 balances with spring forces of respective springs 22 and 27, and opens with an opening area according to the position of the spool. The first valve 20 and the second valve 25 control the flow rate of the passing working oil by the area of the opening changing in response to the energized amount of the solenoids 21 and 26.

The first valve 20 controls the flow of the working oil discharged from the hydraulic cylinder 2. The first valve 20 is connected to a tank passage 13 connected to a tank 9, and a discharge passage 14 communicating with the bottom side chamber 7 of the hydraulic cylinder 2.

The first valve 20 successively switches from a check position 20A that allows only the flow of the working oil from the tank passage 13 to the discharge passage 14, to a communicating position 20B that allows the flow of the working oil from the discharge passage 14 to the tank passage 13, according to the energized amount of the solenoid 21. When the energized amount of the solenoid 21 is zero or not more than an open valve energized amount of the first valve 20, the first valve 20 will be in the check position 20A due to the spring force of the spring 22. Namely, the first valve 20 increases in the opening area that communicates the discharge passage 14 with the tank passage 13, in other words, increases in an area of the flow passage of working oil guided from the discharge passage 14 to the tank passage 13, by increasing the energized amount of the solenoid 21, and controls the flow rate of the working oil guided from the discharge passage 14 to the tank passage 13.

The second valve 25 controls the flow of working oil supplied from a pump 8 to the hydraulic cylinder 2. The second valve 25 is connected to a discharge passage 11 connected to the pump 8 and through which working oil discharged from the pump 8 is guided, and a supply passage 12 communicating with the bottom side chamber 7 of the hydraulic cylinder 2.

The second valve 25 successively switches from a closed position 25A that disconnects the communication of the discharge passage 11 with the supply passage 12 to an open position 25B that communicates the discharge passage 11 with the supply passage 12, according to the energized amount of the solenoid 26. When the energized amount of the solenoid 26 is zero or not more than the open valve energized amount, the second valve 25 will be in the closed position 25A due to the spring force of the spring 27. The second valve 25 increases in the opening area (flow passage area) of the discharge passage 11 to the supply passage 12 by the increase in the energized amount of the solenoid 26, and controls the flow rate of the working oil guided from the discharge passage 11 to the supply passage 12.

The supply passage 12 is provided with a check valve 16 that allows only the flow of the working oil from the pump 8 to the bottom side chamber 7 of the hydraulic cylinder 2.

The supply passage 12 and the discharge passage 14 communicate with the bottom side chamber 7 of the hydraulic cylinder 2 via a common passage 15 to which both passages merge. Alternatively, the supply passage 12 and the discharge passage 14 may each communicate with the bottom side chamber 7 of the hydraulic cylinder 2 independently.

The control device 100 is configured of a microcomputer including a CPU (central processing unit), a ROM (read only memory), a RAM (random access memory), and an I/O interface (input/output interface). The RAM stores data in processings by the CPU, the ROM stores control programs of the CPU in advance, and the I/O interface is used for inputting and outputting information between connected machines. The control device 100 may be configured of a plurality of microcomputers.

When there is an operational input through the main volume 101 (see FIG. 2), which input causes the hydraulic cylinder 2 to contract, the control device 100 supplies a current to the solenoid 21 of the first valve 20 to control an action of the first valve 20, while blocking a supply of a current to the solenoid 26 of the second valve 25. Accordingly, the first valve 20 opens from the check position 20A by an opening degree according to the energized amount, and communicates the discharge passage 14 with the tank passage 13. The second valve 25 becomes the closed position 25A, and blocks the passage of the working oil. Moreover, since the check valve 16 is provided in the supply passage 12, no working oil of the bottom side chamber 7 will be discharged through the supply passage 12. Therefore, the working oil of the bottom side chamber 7 is controlled to the flow rate according to the opening area of the first valve 20, and is discharged to the tank 9. Accordingly, the working oil is discharged from the bottom side chamber 7 by the self-weight of the load 1, and the hydraulic cylinder 2 contracts to lower the load 1.

When there is an operational input through the main volume 101, which input causes the hydraulic cylinder 2 to extend, the control device 100 supplies a current to the solenoid 26 of the second valve 25 to control an action of the second valve 25, while blocking the supply of a current to the solenoid 21 of the first valve 20. Therefore, the first valve 20 becomes in the check position 20A, and blocks the flow of working oil from the discharge passage 14 to the tank passage 13. Moreover, the second valve 25 opens from the closed position 25A by an opening degree according to the energized amount, and communicates the discharge passage 11 with the supply passage 12. Therefore, the working oil discharged from the pump 8 is controlled to a flow rate according to an opening area of the second valve 25, and is guided to the bottom side chamber 7. Accordingly, the hydraulic cylinder 2 extends due to the working oil being supplied to the bottom side chamber 7, and lifts the load 1.

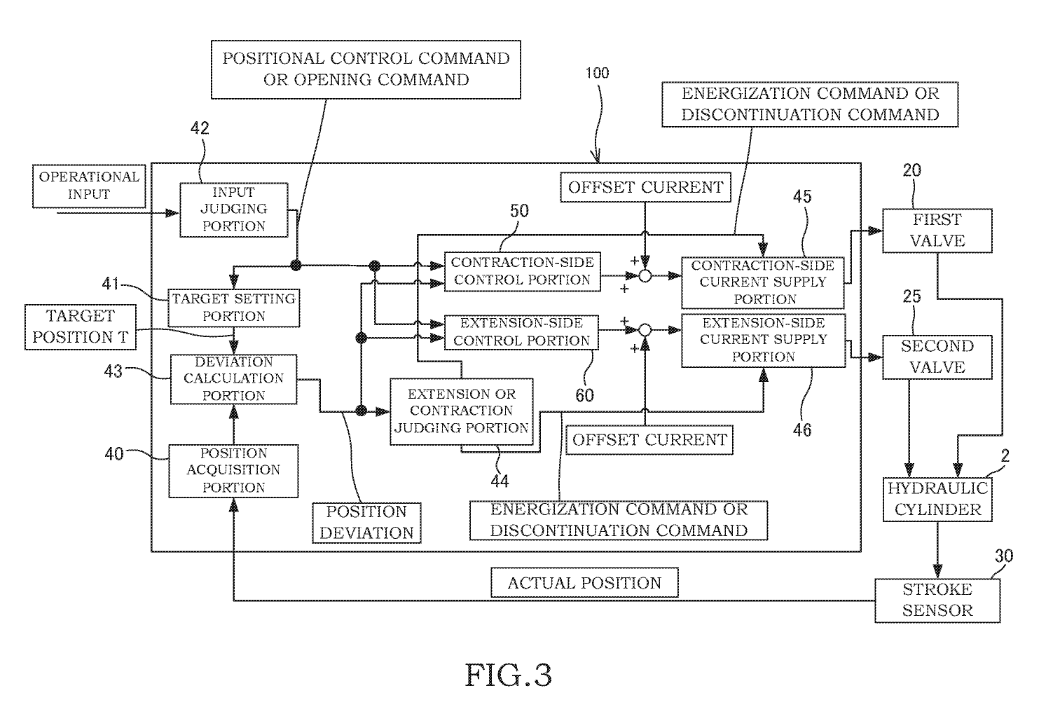

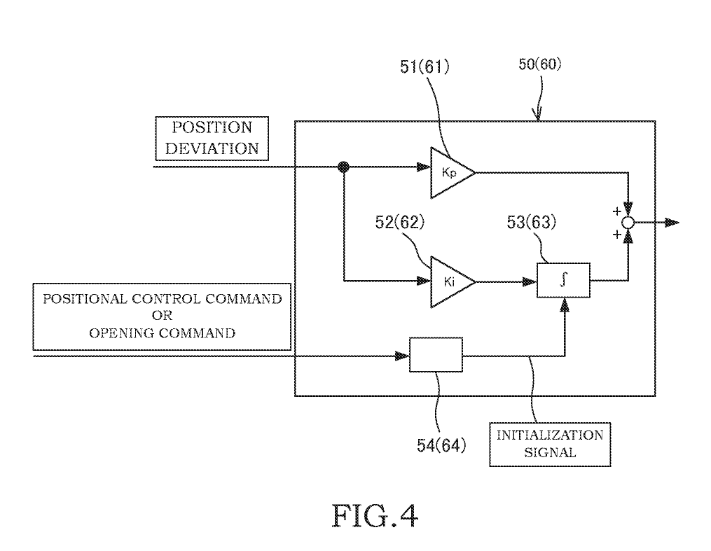

The following describes a specific configuration of the control device 100, with reference to FIG. 3 and FIG. 4.

As shown in FIG. 3, the control device 100 has a position acquiring portion 40 that acquires an extended or contracted position (actual position) of the hydraulic cylinder 2 detected by the stroke sensor 30, a target setting portion 41 that sets a target position T of the hydraulic cylinder 2 in response to an operational input by the worker, a contraction-side control portion 50 serving as a control portion that controls an energized amount of the first valve 20, an extension-side control portion 60 serving as a control portion that controls an energized amount of the second valve 25, an input judging portion 42 that judges the type of the operational input by the worker, a deviation calculation portion 43 that calculates a position deviation between the actual position of the hydraulic cylinder 2 acquired by the position acquiring portion 40 and the target position T set by the target setting portion 41, an extension or contraction judging portion 44 that judges whether to extend or to contract the hydraulic cylinder 2 on the basis of the position deviation, a contraction-side current supply portion 45 that supplies a current to the solenoid 21 of the first valve 20 by an energizing amount according to a command current value outputted from the contraction-side control portion 50 and an offset current value determined in advance, and an extension-side current supply portion 46 that supplies a current to the solenoid 26 of the second valve 25 by an energizing amount according to a command current value outputted from the extension-side control portion 60 and the offset current value determined in advance.

In the control device 100, the contraction-side control portion 50 and the extension-side control portion 60 have similar configurations to each other. Moreover, the contraction-side current supply portion 45 and the extension-side current supply portion 46 have similar configurations to each other. Therefore, in the following descriptions, configurations related to the contraction-side control portion 50 and the contraction-side current supply portion 45 for controlling the first valve 20 are described as an example, and descriptions related to the extension-side control portion 60 and the extension-side current supply portion 46 are omitted as appropriate. The reference numbers inside the parentheses in FIG. 4 represent the configurations of the extension-side control portion 60 corresponding to each configuration of the contraction-side control portion 50.

The input judging portion 42 judges whether the operational input of the main volume 101 by the worker is either an opening command to make the first valve 20 in a predetermined set opening degree regardless of the actual position of the hydraulic cylinder 2 and perform opening control that contracts the hydraulic cylinder 2 by self-weight of the working machine, or is a positional control command to make the opening degree of the first valve 20 be an opening degree smaller than the set opening degree according to the operational input amount of the main volume 101, to control the extended or contracted position of the hydraulic cylinder 2. In the positional control, the opening degree of the first valve 20 is controlled within a range of not more than the set opening degree. Namely, the set opening degree is equivalent to a maximum opening degree controlled by the control device 100. In the present embodiment, the set opening degree is set as fully open (100%). Not limited to this however, the set opening can be set to any value.

When the dial of the main volume 101 is operated to not less than “1” but less than “2”, the input judging portion 42 receives an opening command. When the dial of the main volume 101 is operated to be not less than “2” but not more than “10”, the input determining portion 42 receives a positional control command. The positional control command includes information of an operational input amount of to where the dial has been operated to, between “2” and “10”. The judged result of the input judging portion 42 is inputted to each of the target setting portion 41 and the contraction-side control 50 and extension-side control portion 60.

The target setting portion 41 sets the target position T to any negative value, when the operational input is judged by the input judging portion 42 as the opening command. Moreover, the target setting portion 41 sets the target position T to a positive value according to the operational input amount, when the input judging portion 42 judges the operational input as the positional control command. The setting of the target position T will be described in detail later.

The deviation calculation portion 43 calculates the position deviation being a difference between the actual position of the hydraulic cylinder 2 acquired from the position acquiring portion 40, more specifically the actual position of the piston 5, and the target position T of the piston 5 of the hydraulic cylinder 2 set by the target setting portion 41 on the basis of the operational input by the worker. The position deviation calculated by the deviation calculation portion 43 also includes a positive or negative sign representing a magnitude relationship between the target position T and the actual position, in addition to information of the magnitude (absolute value).

The extension or contraction judging portion 44 judges whether to contract or extend the hydraulic cylinder 2 by judging the positive or negative of the sign of the position deviation, in other words, the magnitude relationship between the target position T and the actual position. Namely, by the extension or contraction judging portion 44, judgment is made on whether to actuate the first valve 20 or the second valve 25.

The contraction-side control portion 50 is capable of performing the positional control that makes the opening degree of the first valve 20 in a predetermined opening degree (<fully open) to control the extended or contracted position of the hydraulic cylinder 2 when the input judging portion 42 judges that the operational input is the positional control command, and the opening control that makes the opening degree of the first valve 20 fully open regardless of the actual position of the hydraulic cylinder 2 when the input judging portion 42 judges that the operational input is the opening command.

As shown in FIG. 4, the contraction-side control portion 50 has a proportional gain output portion 51 that outputs a command current value supplied to the first valve 20 on the basis of the position deviation, an integral gain output portion 52 that outputs a command current value supplied to the first valve 20 on the basis of the position deviation, an integrator 53 that adds and accumulates the command current values outputted by the integral gain output portion 52 and outputs the accumulated value, and a resetting portion 54 that initializes the value accumulated in the integrator 53 according to the judging result by the input judging portion 42.

The proportional gain output portion 51 multiplies a proportional gain Kp to the position deviation calculated by the deviation calculation portion 43, and outputs this as the command current value.

The integral gain output portion 52 multiplies an integral gain Ki to the position deviation calculated by the deviation calculation portion 43, and outputs this to the integrator 53 as the command current value.

The integrator 53 adds and accumulates the command current values outputted from the integral gain output portion 52, and outputs the command current value according to the accumulated amount.

The resetting portion 54 switches between whether to guide an initialization signal to the integrator 53 or not according to the judged result by the input judging portion 42, which initialization signal returns the value accumulated in the integrator 53 to the initial value of zero. In a case in which the judged result inputted from the input judging portion 42 is the opening command, the resetting portion 54 inputs the initialization signal to the integrator 53 that returns the accumulated value to zero (initialize). The resetting portion 54 inputs the initialization signal to the integrator 53 while the opening command is continuously inputted. Therefore, while the dial of the main volume 101 is operated to be “1” and the opening command is continuously outputted, no command current value will be accumulated in the integrator 53 and the command current value from the integrator 53 will be zero. In other words, while the opening command is continuously outputted, no apparent command current value is outputted from the integrator 53, and the control portion will perform a proportional control (P control) just by the proportional gain Kp as the non-integral type control.

In contrast, in a case in which the judging result of the input judging portion 42 is the positional control command, the resetting portion 54 outputs no initialization signal. In this case, the contraction-side control portion 50 performs a proportional integral control (PI control) that controls the outputted command current value on the basis of the proportional gain Kp and the integral gain Ki. As such, the resetting portion 54 switches between whether the contraction-side control portion 50 is to perform the proportional control being the non-integral type control, or the proportional integral control.

The contraction-side current supplying portion 45 supplies a current to the solenoid 21 of the first valve 20 by an energized amount that adds the offset current value to the command current value outputted from the contraction-side control portion 50. Accordingly, the first valve 20 actuates according to the energized amount, and the flow rate of the working oil is controlled.

The offset current value is a current value supplied regardless of the position deviation. By the offset current on the basis of the offset current value, the effect of the current value required until the first valve 20 starts to open (dead zone) is reduced. Therefore, the first valve 20 can be opened promptly by the control on the basis of the position deviation, and thus the responsiveness of the first valve 20 improves.

Next described is the opening control and the positional control by the control device 100.

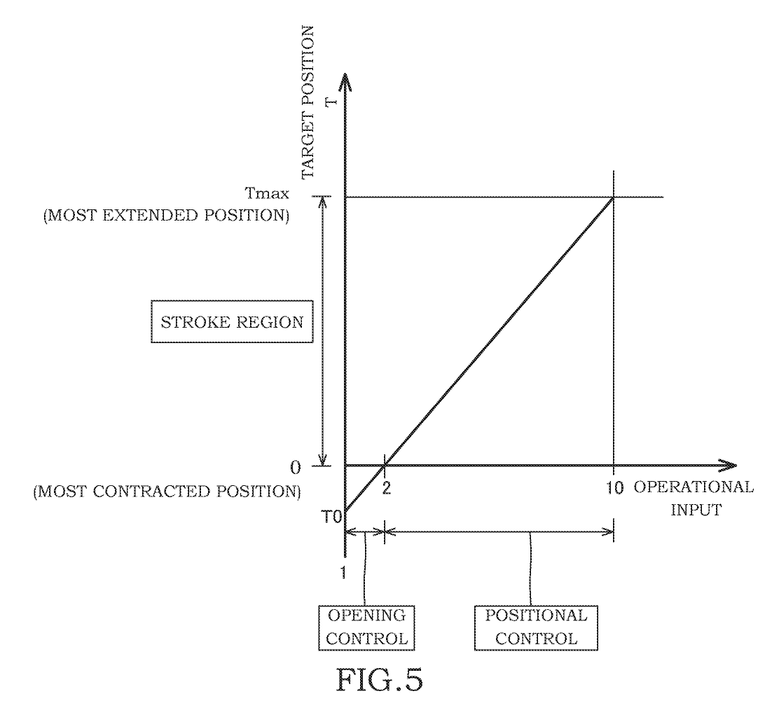

First described with reference to FIG. 5 is a relationship between the target position T set by the target setting portion 41 and the operational input by the worker. In the graph of FIG. 5, the horizontal axis represents the operational input of the main volume 101 by the worker, and the vertical axis represents the target position T of the hydraulic cylinder 2. The target position T has an extending direction of the hydraulic cylinder 2 serve as positive.

When the main volume 101 is operated to the maximum scale of “10”, the target position T is set as a most extended position Tmax, which is a position in which the hydraulic cylinder 2 is moved to an extended stroke end as shown in FIG. 5.

When the main volume 101 is operated to the minimum scale of “2” in the positional control, the target position T is set as “0” as a most contracted position, which is a position in which the hydraulic cylinder 2 is moved to a contracted stroke end. When the operated amount of the main volume 101 is between “2” to “10”, the target position T is set proportionally between the most contracted position of “0” and the most extended position Tmax. As such, within the range of “2” to “10” in which the positional control is performed, the position within the stroke region, namely between the most contracted position and the most extended position of the hydraulic cylinder 2, is set as the target position T.

When the main volume 101 is operated to a position between “1” and “2” (namely, less than “2”) in which the opening command is outputted, the target position T is set as a negative value T0 (<0) in which the opening degree of the first valve 20 is fully open even in either case of the actual position of the hydraulic cylinder 2. Namely, when the main volume 101 is operated to a position less than “2” in which the opening control is performed, the target position T (=T0) is set to a position approaching in a contracting direction than the most contracted position of the hydraulic cylinder 2 by numerical value, in other words, a position outside a range of the stroke region, which exceeds the most contracted position from the stroke range. The position T0 is optionally adjusted in either position of the actual position of the hydraulic cylinder 2 within the stroke region, so that a position deviation generates that causes energizing with a current value to make the first valve 20 fully open. This causes the position deviation to always become a negative value regardless of the actual position when the target position T is set as the position T0, and an energizing amount that makes the first valve 20 fully open is supplied.

Next described is the positional control.

When the main volume 101 is operated to any position between “2” to “10” by the worker, the input judging portion 42 judges that the operational input is the positional control command. The target setting portion 41 sets the target position T according to an operated position, on the basis of the operated position (operated amount) of the positional control command and the graph shown in FIG. 5. The target position T set as such is inputted to the deviation calculation portion 43, as shown in FIG. 3.

The deviation calculation portion 43 deducts the actual position acquired by the position acquisition portion 40 from the inputted target position T, to calculate the position deviation. The calculated position deviation is inputted into each of the contraction-side control portion 50, the extension-side control portion 60, and the extension or contraction judging portion 44.

When the position deviation is inputted to the extension or contraction judging portion 44, the extension or contraction judging portion 44 judges whether the sign of the position deviation is positive or negative. The extension or contraction judging portion 44 judges to extend the hydraulic cylinder 2 when a value of the target position T is greater than a value of the actual position, and the sign of the inputted position deviation is positive. In this case, the extension or contraction judging portion 44 outputs an energization command to the extension-side current supplying portion 46 to energize the second valve 25, and outputs a discontinuation command to discontinue the energization of the first valve 20.

The extension or contraction judging portion 44 judges to contract the hydraulic cylinder 2 when a value of the target position T is smaller than a value of the actual position and the sign of the position deviation is negative. In this case, the extension or contraction judging portion 44 outputs an energization command to the contraction-side current supply portion 45 to energize the first valve 20, and outputs a discontinuation command to the extension-side current supply portion 46 to discontinue the energization of the second valve 25.

The following describes an example of a case in which the action of the first valve 20 is controlled to contract the hydraulic cylinder 2, in other words a case in which the sign of the position deviation is negative and the position deviation is inputted to the contraction-side control portion 50, and omits descriptions as appropriate for the case in which the action of the second valve 25 is controlled to extend the hydraulic cylinder 2.

The position deviation inputted into the contraction-side control portion 50 and the extension-side control portion 60 is inputted into the proportional gain output portion 51 and the integral gain output portion 52, as shown in FIG. 4. The proportional gain output portion 51 multiplies a predetermined proportional gain Kp with a magnitude (absolute value) of the position deviation, and outputs the value obtained upon multiplication as the command current value. Moreover, the integral gain output portion 52 multiplies an integral gain Ki with the magnitude of the position deviation, and outputs the value obtained upon multiplication as the command current value. The proportional gain Kp and the integral gain Ki are suitably adjusted in advance such that a relationship of the inputted positional deviation with the outputted command current value makes the first valve 20 accomplish a desired action.

The command current value outputted from the integral gain output portion 52 is inputted into the integrator 53. Here, in the positioning control, the initialization command from the resetting portion 54 is not inputted into the integrator 53. Therefore, the integrator 53 continues to add the value of the command current value inputted per control step, and outputs a command current value according to the accumulated command current value.

The contraction-side control portion 50 and the extension-side control portion 60 adds the command current values outputted from the proportional gain output portion 51 and the integrator 53, and outputs the added amount. As shown in FIG. 3, values adding the offset current value to these output values are inputted into the each of the contraction-side current supplying portion 45 and the extension-side current supplying portion 46.

The contraction-side current supply portion 45 supplies a current to the first valve 20 in response to the energization command inputted from the extension or contraction judging portion 44, in an energized amount of a value adding the command current value from the contraction-side control portion 50 (sum of command current values outputted from the proportional gain output portion 51 and the integrator 53) with the offset current value.

Although the extension-side current supplying portion 46 receives the command current value from the extension-side control portion 60, since the discontinuation command is inputted from the extension or contraction judging portion 44, the supply of the current to the second valve 25 is discontinued.

As such, in the positioning control, the energized amount of the first valve 20 is controlled by the proportional integral control on the basis of the position deviation.

Next describes the opening control.

When the main volume 101 is operated to a position between “1” and “2” by the worker, the input judging portion 42 judges that the operational input is the opening command. The target setting portion 41 sets the target position T as the position T0 at a position in the contracting direction than the most contracted position (=0) as shown in FIG. 5, on the basis of the judged result of the input judging portion 42. The target position T set as such is inputted to the deviation calculation portion 43. Moreover, the judgment result of the input judging portion 42 is inputted to the resetting portion 54.

The deviation calculation portion 43, as with the positioning control deducts an actual position from the target position T, to calculate the position deviation. In the opening control, the target position T is set to the position T0 being a negative value, and thus the position deviation will always be a negative value regardless of the actual position. The calculated position deviation is inputted to the extension or contraction judging portion 44.

Since a position deviation of a negative value is inputted into the extension or contraction judging portion 44, an energization command is outputted to the contraction-side current supplying portion 45 to energize the first valve 20, and a discontinuation command is outputted to the extension-side current supply portion 46 to discontinue the energizing of the second valve 25.

Here, when the main volume 101 is operated to any position between “2” and “10”, and the main volume 101 is switched to a position below “2” while the energizing amount of the second valve 25 is positionally controlled to cause the hydraulic cylinder 2 to extend, the command to the second valve 25 is switched from the energization command to the discontinuation command, and also the command to the first valve 20 is switched from the discontinuation command to the energization command. As such, when the main volume 101 is switched to a position below “2”, the solenoid valve subjected to be controlled will also switch over from the second valve 25 to the first valve 20.

As shown in FIG. 4, the position deviation inputted to the contraction-side control portion 50 is inputted to the proportional gain output portion 51 and the integral gain output portion 52, and command current values are outputted from each of the proportional gain output portion 51 and the integral gain output portion 52, as with the positional control.

The command current value outputted from the integral gain output portion 52 is inputted into the integrator 53. Here, in the opening control, since the initialization command from the resetting portion 54 is inputted to the integrator 53, the command current value accumulated in the integrator 53 becomes zero per control step, and is initialized. Therefore, in the opening control, the command current value outputted from the integrator 53 becomes zero (no command current value will be outputted apparently). This is the same with the extension-side control portion 60 that controls the second valve 25, which second valve 25 does not operate at the time of the contraction operation, and no integral value is accumulated in the integrator 53 in the extension-side control portion 60 during opening control.

Therefore, the contraction-side control portion 50 outputs only the command current value outputted from the proportional gain output portion 51, and a value adding an offset current value to this output value is inputted into the contraction-side current supply portion 45.

As with the contraction-side control portion 50, the extension-side control portion 60 also only outputs the command current value outputted from the proportional gain output portion 51, and a value adding an offset current value to this outputted value is inputted to the extension-side current supplying portion 46.

As with the positional control, the contraction-side current supply portion 45 supplies a current to the first valve 20 on the basis of the energization command, in an energized amount of a value adding the command current value from the contraction-side control portion 50 (equivalent to the value of the command current value outputted from the proportional gain output portion 51) with the offset current value.

The extension-side current supplying portion 46 discontinues the supply of electric power to the second valve 25, on the basis of the discontinuation command.

The energized amount supplied as such makes the opening degree of the first valve 20 fully open. By the first valve 20 becoming fully open, the bottom side chamber 7 of the hydraulic cylinder 2 communicates with the tank 9 and becomes the tank pressure. Therefore, hardly no resistance is applied to the flow of working oil discharged from the bottom side chamber 7, and the hydraulic cylinder 2 contracts by the maximum speed by the self-weight of the working machine.

As such, in the opening control, the energizing amount of the first valve 20 is controlled by the non-integral type proportional control by the control portion.

With work vehicles, depending on the work details, there are works performed while controlling the working machine at a predetermined height position due to the positional control, and works performed while running in a state in which the working machine is touching the ground by its self-weight due to the opening control.

Here, since the opening control applies a negative position deviation due to the setting of the target position T, in a case in which the opening control is performed by the proportional integral control, a negative integral value continues to accumulate in the integrator 53 while the opening control is performed. Therefore, the command current value outputted from the integrator 53 also become a negative value.

Moreover, in the control device 100, even when the energized amount of the first valve 20 is controlled by the contraction-side control portion 50, the command current value is outputted also to the extension-side current supply portion 46 from the extension-side control portion 60 to ensure the continuality of the control accompanying the switchover in working direction of the extending or contracting. Namely, in the control device 100, in either case of the extending/contracting direction and control method (opening control and positional control), the contraction-side control portion 50 and the extension-side control portion 60 output a command current value according to the position deviation.

Therefore, in a case in which the opening control is performed by the proportional integral control, when the work is performed while the hydraulic cylinder 2 is maintained at the contracted stroke end by the opening control of the contraction-side control portion 50, a negative integral value will be continuously accumulated to the integrator 53 also in the extension-side control portion 60.

In such a case, even when the solenoid valve subjected to be controlled is switched from the first valve 20 to the second valve 25 to attempt to lift the working machine, due to the negative integral value accumulated in the integrator 53 of the extension-side control portion 60, the command current value outputted from the extension-side control portion 60 will decrease. Namely, until the command current value outputted from the proportional gain output portion 61 of the extension-side control portion 60 exceeds the command current value outputted from the integrator 53, no positive command current value is outputted from the extension-side control portion 60, and the second valve 25 does not activate. Therefore, the start of activation of the second valve 25 becomes delayed by the amount of the negative integral value accumulated in the integrator 53, and responsiveness decreases of when the working machine is lifted due to the positional control from a state at the contracted end due to the opening control.

On the other hand, in the control device 100, since the opening control is performed by the non-integral type proportional control, even if the opening controlled state continues, no negative integral value accumulates in the integrator 53. Therefore, when the hydraulic cylinder 2 is extended from the opening controlled state, the current can be supplied promptly to the second valve 25. Therefore, the positional control can be performed with good accuracy while reducing the steady-state deviation by the proportional integral control, and can improve responsiveness in the lifting of the working machine from the opening controlled state.

In particular, with a work vehicle, the work of preparing and the like is performed while reciprocating from end to end of the agricultural land. Namely, with a work vehicle, the preparation work is performed while running forward in an opening controlled state, next the traveling direction is reversed by once lifting the working machine due to the positional control, and then work is performed by lowering the working machine due to the opening control and traveling back. As such, the working machine frequently repeats lowering due to the opening control and lifting due to the positional control; thus, by improving the responsiveness in switching from the opening control to the positional control for the lifting, the work efficiency by the work vehicle can be improved remarkably.

Next describes a modification of the present embodiment.

In the above embodiment, the contraction-side control portion 50 and the extension-side control portion 60 perform the opening control by the proportional control on the basis of the position deviation as the non-integral type of control. In contrast, the control portion may perform the opening control by an open-loop control on the basis of the target position T, as the non-integral type of control. In this case, when the operational input is judged as the opening control by the input judging portion 42, it may be configured such that the target position T is inputted in the open-loop circuit, and the contraction-side current supply portion 45 energizes the first valve 20 on the basis of a command current value outputted from the open-loop circuit on the basis of the target position T. In such a case, an effect similar to the above embodiment is achieved.

Moreover, in the above embodiment, the extension-side control portion 60 and the contraction-side control portion 50 have similar configurations to each other. In comparison, the contraction-side control portion 50 does not need to have the resetting portion 54. As long as the resetting portion 54 is provided in the extension-side control portion 60, the responsiveness can be improved in the switching from the opening control to the positional control for lifting.

Moreover, in the present embodiment, the target position T is set with the extending direction serving as positive. Moreover, the target position T makes the contraction end of the hydraulic cylinder 2 correspond to “0”, and the target position Tat the time of the opening control is the negative value T0. Such a relationship between the target position T and the position of the hydraulic cylinder 2 is only one example, and is not limited to this. For example, the target position T may be set with the contraction direction as positive. Moreover, for example, when the extending direction is referred to as positive, the contraction end may be any positive position, and the target position T at the time of the opening control may be a positive value smaller than a position corresponding to the contraction end. Namely, in the control device 100, at the time of the opening control, as long as the target position T is set to achieve a position deviation that ensures the first valve 20 to be fully open regardless of the actual position of the hydraulic cylinder 2 exceeding the most contracted position from the stroke region of the hydraulic cylinder 2, how the target position T is set may be in any way.

According to the above embodiment, the following effects are exerted.

In the control device 100, since the opening control is performed by the non-integral type proportional control, even if the opening controlled state continues, no negative integral value accumulates in the integrator 53. Therefore, when the hydraulic cylinder 2 is extended from the opening controlled state, a current can be promptly supplied to the second valve 25. Thus, the positioning control can be performed with good accuracy while reducing the steady-state deviation by the proportional integral control, and can improve the responsiveness in the lifting of the working machine from the opening controlled state.

In particular, with a work vehicle, since the lowering due to the opening control and the lifting due to the positional control are frequently repeated, the work efficiency due to the working machine can be improved remarkably by improving the responsiveness in switching from the open control to the positional control for the lifting.

Configurations, operations, and effects of the embodiment of the present invention will be summarized below.

A lifting control device 100 of a working machine configured to control movements of a lifting device 10, which lifting device 10 includes a hydraulic cylinder 2 that lifts and lowers a working machine installed on a work vehicle, and a solenoid valve (first valve 20, second valve 25) that controls a flow of working oil supplied to and discharged from the hydraulic cylinder 2, includes: a position acquisition portion 40 configured to acquire an extended or contracted position of the hydraulic cylinder 2; a target setting portion 41 configured to set a target position T of the hydraulic cylinder 2 according to an operational input by a worker; a control portion (contraction-side control portion 50, extension-side control portion 60) configured to control an energized amount of the solenoid valve (first valve 20, second valve 25); and an input judging portion 42 configured to judge whether the operational input is an opening command to perform an opening control in which an opening degree of the solenoid valve (first valve 20, second valve 25) is made to be a predetermined set opening degree (fully open) regardless of an extended or contracted position of the hydraulic cylinder or is a positional control command to perform a positional control in which the opening degree of the solenoid valve (first valve 20, second valve 25) is made to be a smaller opening degree than the set opening degree (fully open) according to an operation input amount, to control the extended or contracted position of the hydraulic cylinder 2, wherein the control portion (contraction-side control portion 50, extension-side control portion 60) is configured to perform a proportional integral control on the basis of a position deviation between the target position T set by the target setting position 41 and an actual position acquired by the position acquisition portion 40, and a non-integral type control performing no integration of the position deviation, wherein when the operational input is judged as the positional control command by the input judging portion 42, a position within a stroke region between a most extended position and a most contracted position is set as the target position T according to the operation input amount by the target setting portion 41, and the positional control is performed due the proportional integral control by the control portion (contraction-side control portion 50, extension-side control portion 60), and wherein when the operational input is judged as the opening command by the input judging portion 42, a position T0 exceeding the most contracted position from the stroke region is set as the target position T by the target setting portion 41, and the opening control is performed due to the non-integral type control by the control portion (contraction-side control portion 50, extension-side control portion 60).

Moreover, in the lifting control device 100 of a working machine, the non-integral type control is a proportional control on the basis of the position deviation or an open-loop control on the basis of the target position T.

Moreover, in the lifting control device 100 of a working machine, the control portion (contraction-side control portion 50, extension-side control portion 60) has a resetting portion 54, 64 configured to initialize an integral value accumulated by the proportional integral control.

In these configurations, the opening control is performed by a control in which no position deviation is integrated, and thus no negative integral value will accumulate even if the opening controlled state continues. Therefore, the responsiveness in the lifting control device 100 at the time of the lifting operation of a working machine improves.

The embodiments of the present invention described above are merely illustration of some application examples of the present invention and not of the nature to limit the technical scope of the present invention to the specific constructions of the above embodiments.

This application claims priority based on Japanese Patent Application No.2016-91545 filed with the Japan Patent Office on Apr. 28, 2016, the entire contents of which are incorporated into this specification.

1. A lifting control device of a working machine for controlling movements of a lifting device, the lifting device including a fluid pressure actuator configured to lift and lower a working machine installed on a work vehicle, and a solenoid valve configured to control a flow of working fluid supplied to and discharged from the fluid pressure actuator, the lifting control device comprising:
a position acquisition portion configured to acquire an extended and contracted position of the fluid pressure actuator;
a target setting portion configured to set a target position of the fluid pressure actuator according to an operational input by a worker;
a control portion configured to control an energized amount of the solenoid valve; and
an input judging portion configured to judge whether the operational input is an opening command to perform an opening control in which an opening degree of the solenoid valve is made to be a predetermined set opening degree regardless of an extended or contracted position of the fluid pressure actuator or is a positional control command to perform a positional control in which the opening degree of the solenoid valve is made to be a smaller opening degree than the set opening degree according to an operational input amount, to control the extended or contracted position of the fluid pressure actuator,
wherein the control portion is configured to perform a proportional integral control on the basis of a position deviation between the target position set by the target setting portion and an actual position acquired by the position acquisition portion, and a non-integral type control performing no integration of the position deviation,
wherein when the operational input is judged as the positional control command by the input judging portion, a position within a stroke region between a most extended position and a most contracted position is set as the target position according to the operation input amount by the target setting portion, and the positional control is performed due to the proportional integral control by the control portion, and
wherein when the operational input is judged as the opening command by the input judging portion, a position exceeding the most contracted position from the stroke region is set as the target position by the target setting portion, and the opening control is performed due to the non-integral type control by the control portion.

2. The lifting control device of a working machine according to claim 1, wherein
the non-integral type control is a proportional control on the basis of the position deviation or an open-loop control on the basis of the target position.

3. The lifting control device of a working machine according to claim 1, wherein
the control portion has a resetting portion configured to initialize an integral value accumulated by the proportional integral control.
